(19) United States
(12) Patent Application Publication
(10) Pub. No.: US 2020/0090254 A1
(43) Pub. Date: Mar. 19, 2020

(54) Order System

(71) Applicant: World Picom Corporation, Kanagawa (JP)

(72) Inventor: Takao TERASE, Kanagawa (JP)

(21) Appl. No.: 16/515,343

(22) Filed: Jul. 18, 2019

(30) Foreign Application Priority Data
Sep. 13, 2018 (JP) 2018-171597

(51) Int. Cl. G06Q 30/06

(52) U.S. Cl. CPC G06Q 30/0635

(57) ABSTRACT

A solution according to the present invention includes an identifier determination unit that determines, when one terminal is set on one terminal stand, whether or not an identifier stored by the one terminal is redundantly stored by another terminal, and when the identifier determination unit determines that the identifier is not redundantly stored, the one terminal is permitted to be used with the identifier.

### TECHNICAL FIELD

The present invention relates to an order system including a plurality of terminals and terminal stands.

### RELATED ART

Service managing systems that streamline management and improve service to customers have been put into practical use in restaurants and the like, and such apparatuses use digital information about menu ordering and serving as well as payment and the like, and use terminals, for various sectors, linked to each other via a network.

Japanese Patent No. 3582782 discloses one invention related to such a technique, and specifically, the invention disclosed in Japanese Patent No. 3582782 is implemented with a terminal stand installed at a customer seat and a table terminal that can be set on the terminal stand. The terminal stands are installed at respective customer seats. Each terminal stand is provided with a unique identifier for identifying a customer seat, that is, provided with a unique identifier for identifying an individual terminal stand. The table terminal can be set on any suitable terminal stand. When the table terminal is set on any terminal stand, the table terminal reads the unique identifier set to the terminal stand, stores the identifier data, and enables the table terminal to be used at the customer's seat.

According to the invention described in Japanese Patent No. 3582782, the user may set the portable table terminal on any terminal stand, and the user needs not to pay attention to a predetermined combination requiring a certain table terminal to be set on a certain terminal stand. Furthermore, in a case of low battery of a table terminal, the user can set another table terminal on the terminal stand at his or her customer seat, as a result, data related to the customer seat is taken over, and thus, a user friendly service managing system can be obtained.

### SUMMARY

The inventor has found the following problem in the service managing system described in Japanese Patent No. 3582782. Specifically, in the service managing system described in Japanese Patent No. 3582782, when one terminal is set on a certain terminal stand and then is removed, another terminal may be set on the certain terminal stand before the one terminal is set on another terminal stand, and as a result, the same identifier is used by a plurality of terminals. In this situation where the one terminal and the other terminal use the same identifier in the service managing system described in Japanese Patent No. 3582782, an item ordered using the one terminal is served at a location of the certain terminal stand on which the one terminal used to be set, instead of the currently used position of the one terminal.

Thus, in the case that one terminal is removed from a certain terminal stand and another terminal is set on the terminal stand, the service managing system described in Japanese Patent No. 3582782 requires the one terminal to be set on another terminal stand, such as a dummy stand for example, as soon as possible.

An object of the present invention is to prevent, in an order system in which a plurality of terminals and a plurality of terminal stands on which the respective terminals are set are provided and can be in any combination, each of identifiers of the respective terminal stands to be redundantly used by a plurality of the terminals.

A main feature of an order system according to the present invention is that it includes:

a plurality of terminals capable of transmitting order data;

a plurality of terminal stands each being provided with an identifier, connecting, upon having one terminal of the plurality of terminals set on the terminal stand, to the one terminal, and causing the one terminal to store the identifier; and

a control apparatus that receives the identifier transmitted from each of the terminals and receives the order data transmitted from each of the terminals in association with the identifier,

the terminal stands and the terminals set on the terminal stands being able to be in any combination,

that it further includes:

an identifier determination unit that determines, when the one terminal is set on one of the terminal stands, whether or not the identifier stored by the one terminal is redundantly stored by another terminal; and

an in-progress order operation determination unit that determines, when the identifier determination unit determines that the identifier is redundantly stored, whether or not an order operation using the other terminal is in progress, and that

when the in-progress order operation determination unit determines that the order operation is not in progress, a message indicating that the other terminal is to be set on any of the terminal stands is displayed on the other terminal and use of the other terminal is disabled, and the one terminal is permitted to be used with the identifier.

According to the present invention, when a user sets one terminal on one of terminal stands and thus the one terminal stores an identifier, the one terminal is permitted to be used with the identifier if the identifier stored is not redundantly used by another terminal. Thus, the present invention is free of redundant use of an identifier of each terminal stand by a plurality of terminals, whereby an unwanted scenarios such as that where a product or an ordered item such as food ordered by a terminal is delivered to a location of another terminal or terminal stand can be prevented.

### BRIEF DESCRIPTION OF DRAWINGS

FIG. 1 is a flowchart illustrating operations of an embodiment of an order system according to the present invention;

FIG. 2 is a flowchart illustrating the operations of the embodiment divided into operations individually performed by components;

FIG. 3 is a schematic view illustrating an example of the operations of the embodiment;

FIG. 4 is a schematic view showing another example of the operation of the embodiment;

FIG. 5 is a block diagram illustrating an example of a hardware configuration applicable to the order system according to the present invention;

FIG. 6 is a functional block diagram illustrating an example of a central control apparatus that is one component of the order system; and

FIG. 7 is a functional block diagram illustrating an example of a table terminal that is one component of the order system.

### DETAILED DESCRIPTION

Hereinafter, an embodiment of an order system according to the present invention will be described with reference to the drawings.

### Embodiment

### Configuration According to Embodiment

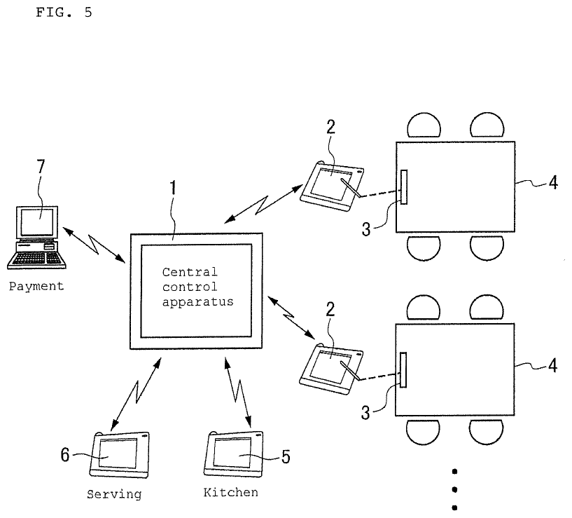

The inventor will describe an example of a hardware configuration applicable to an embodiment of an order system according to the present invention with reference to FIG. 5. FIG. 5 illustrates a configuration that is assumed to be used for a serving system in a restaurant, and involves communications among a plurality of terminals via a central control apparatus 1 for exchanging information signals. The central control apparatus 1 may include a computer. The central control apparatus 1 and each of the terminals may perform wired communications to exchange signals, but perform wireless communications in the illustrated example. Any suitable wireless local area network (LAN) standard may be used.

The plurality of terminals are individually responsible for various respective roles. In FIG. 5, terminals denoted by reference numeral 2 are each a table terminal. The table terminal 2 has a display, that is, an image display unit displaying menu information to be viewable by a customer. The display of the table terminal 2 is a touch panel enabling selection, that is, ordering through an operation of touching the menu screen and the like displayed.

The table terminal 2 incorporates a rechargeable battery as a power source for operations. The table terminal 2 can be set on a terminal stand 3 installed on a table 4 at which the customer is seated. When the table terminal 2 is set on the terminal stand 3, a power supply circuit incorporated in the terminal stand 3 supplies charging power to the battery of the table terminal 2. A plurality of the terminal stands 3 are distributed among the respective tables. The terminal stand 3 is not limited to a table seat and may also be installed at a counter seat or the like. The plurality of table terminals 2 are prepared to be at least the same in number as the terminal stands 3.

The table terminal 2 is operable in a state of being set on the terminal stand 3 and in a state of being separated from the terminal stand 3, and can be operated in any of these states. Among various terminals according to the embodiment, the table terminal corresponds to the term “terminal” in the claims.

Each terminal stand 3 incorporates an identifier setting unit such as a nonvolatile memory in which an identifier for individually identifying the terminal stand 3 can be set. When the user sets the table terminal 2 on a certain terminal stand 3, the terminal stand 3 and the table terminal 2 are electrically connected to each other via a contact, and the identifier of the terminal stand 3 is read by the table terminal 2. Thereafter, the certain terminal stand 3 and the certain specific table terminal 2 are linked to each other by the identifier.

Thus, when the user sets a table terminal 2, different from the certain table terminal 2, on the specific terminal stand 3, the other table terminal 2 reads the identifier of the terminal stand 3, and takes over data about orders identified by the identifier, that is, order data. The configuration provided with such a function is effective, for example, for a situation where the table terminal 2 becomes inoperable due to low battery, and thus needs to be replaced with another table terminal 2 and for the other like situations.

However, when the user sets one terminal 2 on one terminal stand 3 and then sets another terminal 2 on the one terminal stand 3 in place of the one terminal 2, there are two terminals 2 that have read the same identifier. In view of this, in the present embodiment, the reading of the identifier by the other terminal 2 is disabled under a certain condition so there will be no two terminals 2 with the same identifier read. The certain condition and how the reading of the identifier is disabled according to the present invention will be described in detail later.

When the user places an order by operating the table terminal 2, order data is transmitted to the central control apparatus 1 together with data about the identifier of the table terminal 2. The central control apparatus 1 transmits the order data together with the identifier data about the table terminal 2 to a kitchen terminal 5 placed in a kitchen and a serving terminal 6 placed on a serving table. The central control apparatus 1 transmits order history, total price, and other types of data useful to the customer to each table terminal 2 identified by the identifier, and causes the table terminal 2 to display these pieces of data.

In the kitchen, a cook performs cooking in accordance with the order menu displayed on the kitchen terminal 5, and deletes the menu displayed on the kitchen terminal 5 upon completing the cooking. The deleted menu information is transmitted to the serving terminal 6 via the central control apparatus 1, and the menu is displayed on the serving terminal 6 together with the identification data about the table terminal 2. With the menu displayed on the table terminal 2, a waiter can realize that the cooking has been completed. The serving clerk carries the prepared dishes to a table or counter seat corresponding to the identification data about the terminal stand. The waiter deletes the menu displayed on the serving terminal upon serving the ordered menu.

The data according to the operation on the serving terminal 6 is transmitted to the central control apparatus 1, and the central control apparatus 1 accumulates order data, cooking data, and serving data with these pieces data classified based on the identifiers of the terminal stands 3, and calculates and stores the current total price data and other useful data. An example of the useful data includes calculation data about the prices based on the number of customers splitting the bill for each table terminal 2. The central control apparatus 1 causes the relevant table terminal 2 to display the calculation data.

The customer leaving the restaurant after finishing eating and drinking presses a check button of the table terminal 2 or performs the other like operation to instruct calculation of the bill. A signal instructing calculation of the bill is sent to the central control apparatus 1 together with a signal indicating the identifier of the terminal stand 3, and the central control apparatus 1 calculates the bill corresponding to the order data associated with the identifier of the terminal stand 3, and transmits the bill to a payment terminal 7.

The payment terminal 7 accepts payment from the customer based on payment data transmitted from the central control apparatus 1, and performs an input operation for payment completion. Each time the input operation for payment completion is performed, the central control apparatus 1 performs data processing useful for management including integrating the sales amount, as well as classifying, analyzing, and accumulating the ordered menus. In addition, in a case of a branch of a franchise, the central control apparatus 1 may be connected to the franchise headquarters via a point of service (POS) system.

An example of the serving system according to the present invention is schematically described above. The order system according to the present invention solves the above-mentioned problem in such a serving system.

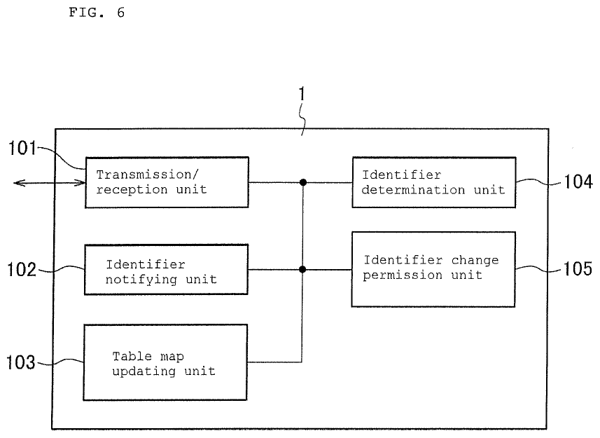

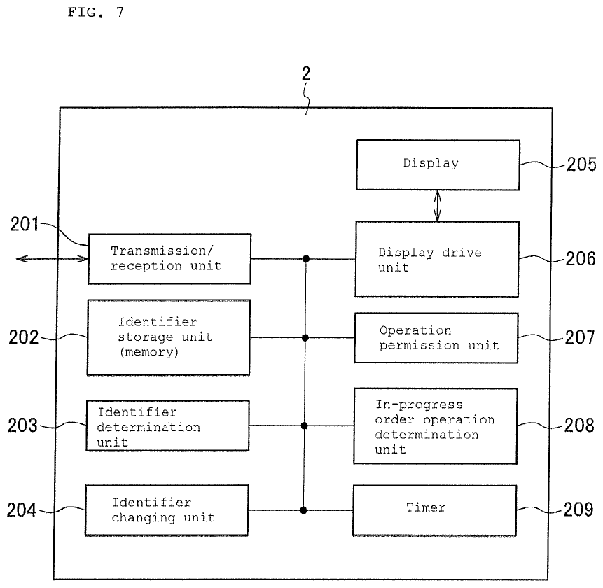

As in the example illustrated in FIG. 5, the serving system uses various terminals, in various sectors, in charge of respective functions, and a feature of the present invention lies in the relationship between the table terminal 2 and the terminal stand 3. FIG. 6 is a block diagram of the central control apparatus 1 according to the present invention, illustrating functions implementing characteristic functions of the present invention. FIG. 7 is a block diagram of the table terminal according to the present invention, illustrating functions implementing characteristic functions of the present invention.

Each table terminal 2 has a control unit mainly composed of a central processing unit (CPU), a memory, a display, and the like. The display is a touch panel, and functions as an image display unit that displays a menu and various types of information, and also functions as an input device. The control unit controls transmission and reception of signals between the table terminal 2 and the terminal stand 3, transmission and reception of signals to and from the central control apparatus 1, and writing and reading to and from the memory, as well as the displaying by the display.

FIG. 7 is a functional block diagram of the table terminal 2. The table terminal 2 includes a transmission/reception unit 201, an identifier storage unit 202 including a memory, an identifier determination unit 203, an identifier changing unit 204, a display 205, a display drive unit 206, an operation permission unit 207, an in-progress order operation determination unit 208, and a timer 209.

As illustrated in FIG. 6, the central control apparatus 1 includes a transmission/reception unit 101 that exchanges signals with the external, an identifier notifying unit 102, a table map updating unit 103, an identifier determination unit 104, and an identifier change permission unit 105.

To each terminal stand 3, a specific identifier is set in advance using a nonvolatile memory capable of storing data without the need for performing a memory holding operation, so that the terminal stand 3 can be individually identified. When one terminal 2 is set on one terminal stand 3, this terminal 2 reads the identifier of the terminal stand 3 and stores the identifier in the memory of the terminal 2. This data stored in the memory is held until it is rewritten.

### Summary of Operation According to Embodiment

Next, operations of the embodiment according to the present invention will be described, and the operations are performed in a state where a table terminal set on one terminal stand is removed from the one terminal stand so that another table terminal may be set on the one terminal stand.

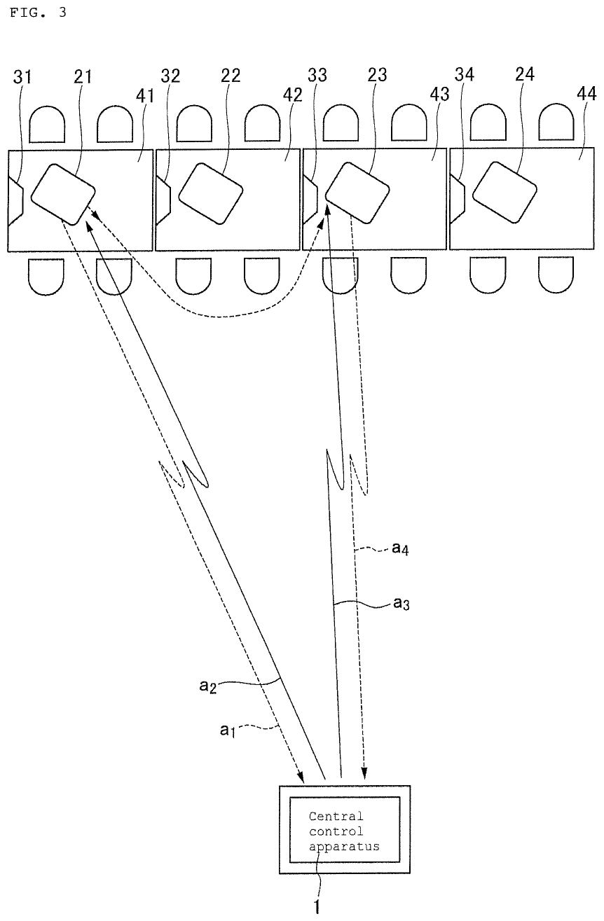

FIG. 3 illustrates a case assumed in the present invention, involving four tables, four terminal stands installed on the respective tables, and four table terminals set on the respective terminal stand. The four tables are denoted by reference numerals 41 to 44 and are referred to as first to fourth tables in order from the left side. Similarly, the four terminal stands are denoted by reference numerals 31 to 34 and are referred to as first to fourth terminal stands in order from the left side. The four table terminals are denoted by reference numerals 21 to 24 and are referred to as first to fourth table terminals in order from the left side.

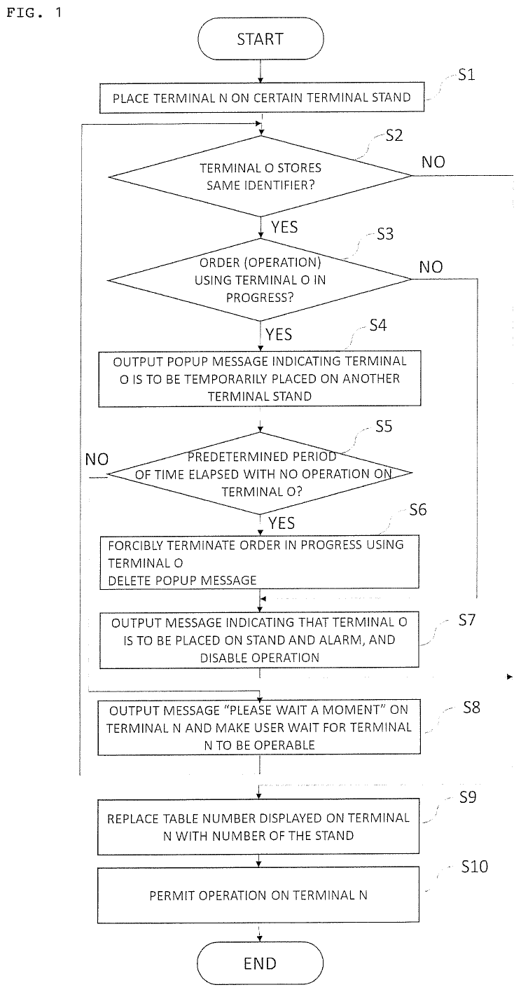

FIG. 3 illustrates a case where the table terminal 21 set on the first terminal stand 31 is removed from the first terminal stand 31 to be moved to the third table 43. FIG. 1 illustrates operations performed by the terminal stands 31 to 34, the table terminals 21 to 24, and the central control apparatus 1 in the example shown in FIG. 3.

In FIG. 1, a “terminal N” is a table terminal different from any of the table terminals 21 to 24 illustrated in FIG. 3, and has no identifier or stores an identifier not corresponding to an identifier set in a terminal stand different from a terminal stand on which the “terminal N” has been placed. A “terminal O” is a table terminal that has been set on any of the terminal stands 31 to 34 and has been removed from the terminal stand. In the example illustrated in FIG. 3, for the first terminal stand 31, the table terminal 21 removed from the first terminal stand 31 serves as the terminal O, and the table terminal newly set on the first terminal stand 31 serves as the terminal N. The operation steps illustrated in FIG. 1 are denoted by S1, S2, and so on.

In FIG. 1, the terminal N is set on a certain terminal stand in the present embodiment (S1). The “certain terminal stand” is the terminal stand 31 in the example illustrated in FIG. 3. In this example, the table terminal 21 that has been set on the first terminal stand is removed and moved to the third table 43, and the terminal N is set on the first terminal stand 31. When the terminal N is set on the first terminal stand 31, the terminal N reads the identifier of the first terminal stand 31, and the identifier determination unit 203 of the terminal N determines whether or not there is a table terminal storing the identifier that is the same as this identifier (S2).

In the example illustrated in FIG. 3, this step S2 is a step of determining whether or not the first table terminal 21 that has been set on the first terminal stand 31 is set on the third terminal stand 33. When the first table terminal 21 is set on the third terminal stand 33, the identifier changing unit 204 replaces the identifier in the first table terminal 21 with the identifier of the third terminal stand 33. Therefore, there will be no identifier that is the same as the identifier stored in the terminal N, and thus in the example illustrated in FIG. 3, the table number displayed on the terminal N is replaced with the number of the first terminal stand 31 (S9), and in the example illustrated in FIG. 3, the operation permission unit 207 permits the terminal N to be operated (S10).

When the table terminal 21 serving as the terminal O is not set on any of the terminal stands in step S2 described above, the same identifier is redundantly stored in the terminal O and the terminal N. In such a case, the order system proceeds to step S3 to perform a determination step of determining whether or not an order operation using the table terminal 21 serving as the terminal O is in progress. This determination step is performed by the in-progress order operation determination unit 208.

When the order operation by the user is not in progress in step S3, the table terminal 21 outputs an alarm, using a message on the display of the table terminal 21 and sound, prompting the user to set the table terminal 21 on any of the terminal stands, and disables an operation using the table terminal 21 (S7). Then, the order system according to the present embodiment proceeds to steps S9 and S10 described above, where the operation using the terminal N is permitted.

When an order operation performed by the user using the table terminal 21 serving as the terminal O is in progress in step S3, the table terminal 21 displays a popup message indicating an instruction to temporarily set this terminal on another terminal stand (S4), and then the order system according to the present embodiment proceeds to the next step S5. Step S5 is a step of determining whether or not a predetermined period of time has elapsed with no operation performed on the table terminal 21 serving as the terminal O. Whether or not the predetermined period of time has elapsed is determined with the timer 209.

The order system displays a message “Please wait a moment” on the table terminal serving as the terminal N set on the first terminal stand 31 and makes the user wait for the terminal N to be operable until a predetermined period of time passes in step S5 (S8), and the order system returns to step S2. When the predetermined period of time has elapsed in step S5, the order system forcibly terminates the order that has been in progress using the table terminal 21 serving as the terminal O and deletes the popup message displayed in step S4 (S6). Thereafter, the order system proceeds to steps S7, S9 and S10 described above, and permits an operation on the terminal N.

### Operation of Each Component According to Embodiment

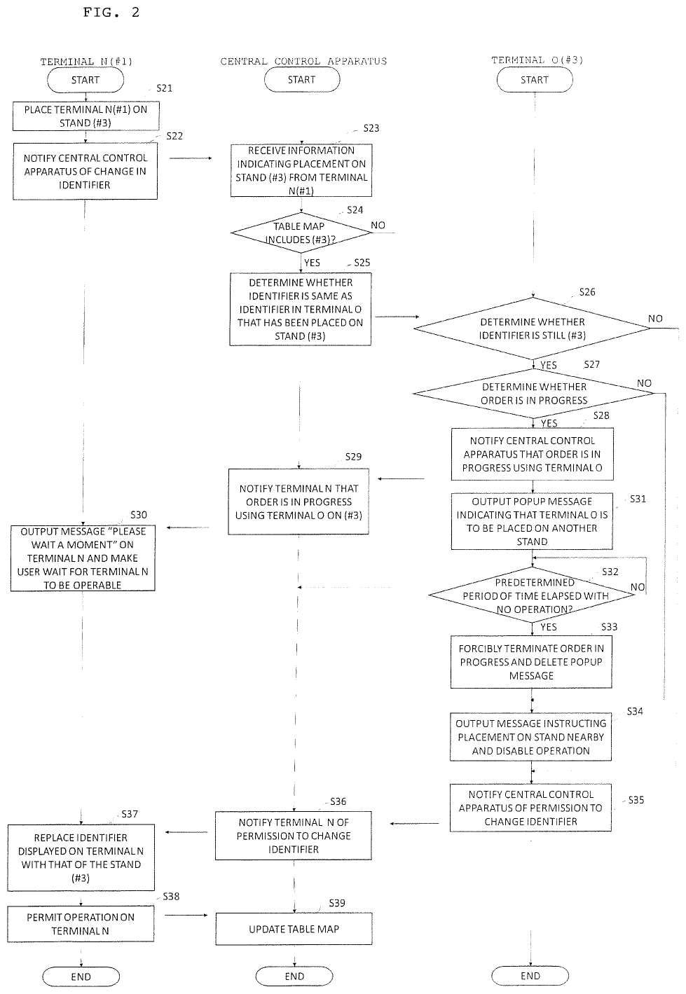

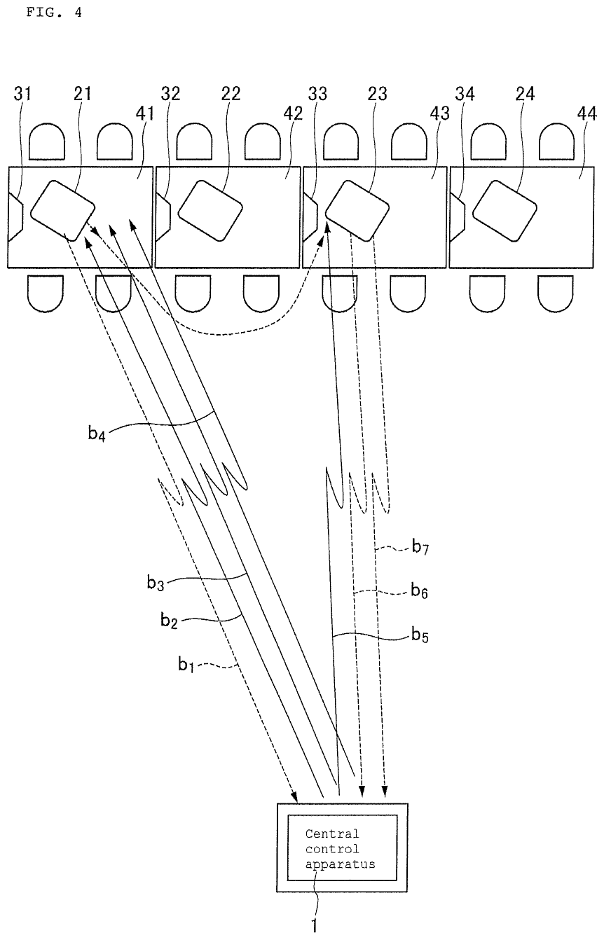

The above operations are overall operations according to the embodiment. Next, with reference to FIG. 2, description is given on operations performed by each of the components according to the embodiment along the time, and specifically, the components are the terminal N, the central control apparatus, and the terminal O. FIG. 2 illustrates operations performed in the case where the first table terminal 21 serving as the terminal O is moved to the third table 43 to be set on the third terminal stand 33, as illustrated in FIGS. 3 and 4. In FIG. 2, the symbol “#” is a symbol indicating an ordinal number and, for example, #1 means first and #2 means second.

In FIG. 2, the user sets the terminal N for the #3 terminal stand 33, that is, the #1 terminal 21 on the #3 terminal stand 33 (S21). The #1 terminal 21 notifies the central control apparatus 1 of a change in the identifier to that of the #3 terminal stand 33 (S22).

The central control apparatus 1 receives information indicating that the #1 terminal 21 has been set on the #3 terminal stand 33, from the #1 terminal 21 via the transmission/reception unit 101 (S23). Then, the identifier determination unit 104 of the central control apparatus 1 determines whether or not a table map includes #3, that is, whether or not the identifier provided to the #3 terminal stand 33 is stored in a table terminal other than the #1 terminal 21 (S24). For the #3 terminal stand 33, the #3 table terminal 23 which has been set thereon serves as the terminal O.

When the #1 terminal 21 is the only table terminal storing the identifier provided to the #3 terminal stand 33 in step S24, the identifier change permission unit 105 of the central control apparatus 1 notifies the #1 terminal 21 serving as the terminal N of an identifier change permission (S39). The #1 terminal 21 serving as the terminal N replaces the identifier therein with the identifier of the #3 terminal stand 33 (S37), and permits the operation on the #1 terminal 21 (S38). The #1 terminal notifies the central control apparatus 1 of the replacement of the identifier with the identifier of the #3 terminal stand 33 and of the permission of the operation on the #1 terminal 21, and the table map updating unit 103 of the central control apparatus 1 updates the table map.

When the #1 terminal 21 is not the only table terminal storing the identifier provided to the #3 terminal stand 33 in step S24, whether or not the identifier is the same as that in the terminal that has been set on the #3 terminal stand 33, that is, the terminal O is determined (S25). Data for this determination is transmitted to the #3 table terminal 23 serving as the terminal O, and the #3 table terminal 23 determines whether or not the identifier therein is still the identifier of the #3 terminal stand 33 (S26).

The identifier of the #3 table terminal 23, serving as the terminal O, no longer being the identifier of the #3 terminal stand 33 in step S26 means that the #3 table terminal 23 has been set on any of the terminal stands and has had the identifier therein switched to another identifier, and the order system proceeds from step S26 to step S35. In step S35, the central control apparatus 1 is notified of the permission to change the identifier in the #3 table terminal 23. The #3 table terminal 23 becomes operable with the identifier changed. The central control apparatus 1 updates the table map in response to the change in the identifier of the #3 table terminal 23 (S39).

When the identifier in the #3 table terminal 23 serving as the terminal O is still the identifier of the #3 terminal stand 33 in step S26, then, the in-progress order operation determination unit of the #3 table terminal 23 determines whether or not an order operation is in progress (S27). When the in-progress order operation determination unit determines that no order operation using the #3 table terminal 23 is in progress, the order system proceeds from step S27 to step S34, where the #3 table terminal 23 outputs a message indicating that the #3 table terminal 23 is to be set on any terminal stand nearby and disables the operation on the #3 table terminal 23. When the #3 table terminal 23 outputs the above message to its display and is set on the terminal stand, the order system proceeds from step S34 to step S35, where the #3 table terminal 23 permits the identifier in the #3 table terminal 23 to be changed and permits an operation on the #3 table terminal 23 by the changed identifier.

When an order operation by the user using the #3 table terminal 23 is in progress in step S27, the #3 table terminal 23 notifies the central control apparatus 1 that the order operation using the #3 table terminal 23 is in progress. In addition to issuing this notification, the #3 table terminal 23 outputs a popup message indicating that the #3 table terminal 23 is to be set on another terminal stand (S31), and waits for the predetermined period of time to elapse with no operation performed (S32). Upon receiving the above notification, the central control apparatus 1 notifies the #1 table terminal, serving as the terminal N, that the order operation using the #3 table terminal 23 is in progress (S29). The #1 table terminal outputs a message “Please wait a moment” to make the user wait for the #1 table terminal to be operable (S30).

When the predetermined period of time has elapsed in step S32, the #3 table terminal 23 serving as the terminal forcibly terminates the order, and deletes the popup message indicating that the #3 table terminal 23 is to be set on another terminal stand (S33). Then, the order system proceeds from step S33 to step S34, where the #3 table terminal 23 outputs a message indicating that the #3 table terminal 23 is to be set on any terminal stand nearby and the operation on the #3 table terminal 23 is disabled.

FIG. 3 illustrates how signals are exchanged between the table terminals and the central control apparatus 1, in a situation where the identifiers in the terminal O and the terminal N are the same and no order operation using the terminal O is in progress. A signal a1 illustrated in FIG. 3 is an identification number change notification signal transmitted from the first table terminal 21 to the central control apparatus 1 when the first table terminal 21 serving as the terminal O is set on the third terminal stand 33. The operation illustrated in FIG. 1 corresponds to a case that a result of the determination in step S2 is “No”.

A signal a2 from the central control apparatus 1 to the #1 table terminal 21 in FIG. 3 indicates a notification about permission to change the identifier due to the absence of redundant identifier and to operate the #1 terminal 21, and corresponds to steps S9 and S10 in FIG. 1.

A signal a3 from the central control apparatus 1 to the #3 table terminal in FIG. 3 indicates a signal for determining whether or not an order operation using the #3 table terminal serving as the terminal O is in progress, and corresponds to step S3 in FIG. 1.

A signal a4 from the #3 table terminal to the central control apparatus 1 in FIG. 3 is a signal used by the #3 table terminal, which has been set on the #3 terminal stand, for notifying the central control apparatus 1 that the order operation is not in progress, and corresponds to “No” in step S3 in FIG. 1. In addition to the notification described above, the signal a4 from the #3 table terminal to the central control apparatus 1 in FIG. 3 is used for causing the #3 table terminal serving as the terminal O, for the #3 terminal stand, to output a message indicating that the #3 table terminal is to be set on any terminal stand and for disabling the operation on the #3 table terminal, as in step S7.

FIG. 4 illustrates how signals are exchanged between the table terminals and the central control apparatus 1, in a situation where the identifiers in the terminal O and the terminal N are the same and an order operation using the terminal O is in progress. A signal b1 illustrated in FIG. 4 is an identifier change signal transmitted from the #1 table terminal to the central control apparatus 1 as a notification when the #1 table terminal that has been set on the #1 terminal stand is set on the #3 terminal stand. This corresponds to step S22 illustrated in FIG. 2. As a result, the central control apparatus 1 transmits a signal b2 to the #1 table terminal, as a notification indicating that the same identifier is being used.

A signal b3 from the central control apparatus 1 to the #1 table terminal in FIG. 4 is a signal indicating that the identifier is the same as the identifier in the #3 table terminal that has been set on the #3 terminal stand, and that the order operation using the #3 table terminal is in progress. This corresponds to step S28 in FIG. 2. Upon receiving the signal, the #1 table terminal outputs a message “Please wait a moment”, to make the user wait for the #1 table terminal to be operable. This corresponds to steps S29 and S30 illustrated in FIG. 2.

A signal b4 in FIG. 4 is a signal indicating that the #3 table terminal that has been set on the #3 terminal stand is set on another terminal stand and that the same identifier is no longer used, and permitting the #1 table terminal to be used with the identifier of the #3 terminal stand. This corresponds to the sequence of proceeding to steps S35 and S36, due to the result of the determination in step S26 in FIG. 2 being “No”.

A signal b5 in FIG. 4 is a signal used by the central control apparatus 1 for causing the #3 table terminal that has been set on the #3 terminal stand to determine whether or not an order operation is in progress. This corresponds to step S27 illustrated in FIG. 2. Upon receiving this determination signal, the #3 table terminal performs the determination operation. When the order operation using the #3 table terminal is in progress, the central control apparatus 1 is notified of such information through a signal b6. This corresponds to step S28 illustrated in FIG. 2.

A signal b7 in FIG. 4 is a signal used by the #3 table terminal, which has been set on the #3 terminal stand, for notifying the central control apparatus 1 that the #3 table terminal is set on any of the terminal stands. This corresponds to step S22 illustrated in FIG. 2.

With the above described configuration, the order system, in which a plurality of terminals and a plurality of terminal stands on which the respective terminals can be individually set are provided and can be in any combination, can prevent redundancy in identifier data.

The order system according to the present invention can be applied to any suitable field. For example, the present invention can be applied as an order system for a service industry including restaurant businesses and beauty salon business, as a part ordering system for production lines in factories, or the like.

What is claimed:

1. An order system comprising:
a plurality of terminals capable of transmitting order data;
a plurality of terminal stands each being provided with an identifier, connecting, upon having one terminal of the plurality of terminals set on the terminal stand, to the one terminal, and causing the one terminal to store the identifier; and
a control apparatus that receives the identifier transmitted from each of the terminals and receives the order data transmitted from each of the terminals in association with the identifier,
the terminal stands and the terminals set on the terminal stands being able to be in any combination,
the order system further comprising:
an identifier determination unit that determines, when the one terminal is set on one of the terminal stands, whether or not the identifier stored by the one terminal is redundantly stored by another terminal; and
an in-progress order operation determination unit that determines, when the identifier determination unit determines that the identifier is redundantly stored, whether or not an order operation using the other terminal is in progress, wherein
when the in-progress order operation determination unit determines that the order operation is not in progress, a message indicating that the other terminal is to be set on any of the terminal stands is displayed on the other terminal and use of the other terminal is disabled, and the one terminal is permitted to be used with the identifier.

2. An order system comprising:
a plurality of terminals capable of transmitting order data;
a plurality of terminal stands, each of the plurality of terminal stands being provided with an identifier and connecting, upon having one terminal of the plurality of terminals set, to the one terminal and causing the one terminal to store the identifier; and
a control apparatus that receives the identifier transmitted from each of the terminals and receives the order data transmitted from each of the terminals in association with the identifier,
the terminal stands and the terminals set on the terminal stands being able to be in any combination,
the order system further comprising:
an identifier determination unit that determines, when the one terminal is set on one of the terminal stands, whether or not the identifier stored by the one terminal is redundantly stored by another terminal; and
an in-progress order operation determination unit that determines, when the identifier determination unit determines that the identifier is redundantly stored, whether or not an order operation using the other terminal is in progress, wherein
when the in-progress order operation determination unit determines that the order operation is in progress, a message indicating that the other terminal is to be set on one of the terminal stands different from the one terminal stand is displayed on the other terminal, and when a predetermined period of time elapses with no operation on the other terminal, the order operation using the other terminal is forcibly terminated.

3. The order system according to claim 2, wherein when the order operation using the other terminal is not in progress, a message indicating that the other terminal is to be set on one of the terminal stands is displayed on the other terminal, and an operation on the other terminal is disabled.

4. The order system according to claim 3, wherein along with the disabling of the operation on the other terminal, the one terminal is permitted to be used with the identifier.

5. The order system according to claim 2, wherein a message indicating that an operation is temporarily disabled is displayed on the one terminal until the predetermined period of time elapses with no operation on the other terminal, and when the identifier stored by the one terminal ceases to be stored by the other terminal, the one terminal is permitted to be used with the identifier.

6. The order system according to claim 1, wherein the one terminal is permitted to be used with an identifier newly stored by the one terminal and while taking over order data associated with the identifier.

7. The order system according to claim 2, wherein the one terminal is permitted to be used with an identifier newly stored by the one terminal and while taking over order data associated with the identifier.

8. The order system according to claim 1, wherein the plurality of terminal stands are distributed among tables for customers, and the terminals transmit the order data based on an operation by the customers.

9. The order system according to claim 2, wherein the plurality of terminal stands are distributed among tables for customers, and the terminals transmit the order data based on an operation by the customers.
